(19) United States
(12) Patent Application Publication
(10) Pub. No.: US 2011/0004521 A1
(43) Pub. Date: Jan. 6, 2011

(54) Techniques For Use In Sorting Partially Sorted Lists

(75) Inventors: Amir Behroozi, Saratoga, CA (US); Kejariwal Arun, San Jose, CA (US); Sapan Panigrahi, Castro Valley, CA (US)

Correspondence Address: Mauriel Kapouytian & Treffert LLP, 151 1st Avenue, #23, New York, NY, 10003, US

(73) Assignee: Yahoo! Inc., Sunnyvale, CA (US)

(21) Appl. No.: 12/498,249

(22) Filed: Jul. 6, 2009

(51) Int. Cl. G06Q 30/00; G06F 7/08; G06F 17/30

(52) U.S. Cl. 705/14.54; 705/14.49; 707/759; 707/769; 707/776; 707/752; 707/753; 707/802; 707/803; 707/812; 707/754

(57) ABSTRACT

Methods and systems are provided for determining whether to use a full sort sorting technique or a merge sort sorting technique to sort a partially sorted list or data set. One or more tables may be utilized to allow such a determination to be made with regard to a first partially sorted list based on parameters associated with the list including a data distribution type, a number of data items in the list, and a ratio of sorted items to unsorted items in the list.

### BACKGROUND

Online advertising continues to grow in importance and scale. This includes sponsored search advertising, where advertisements may be served in connection with user keyword query results. Also increasingly important is targeting online advertising. Advertising can be targeted based on various parameters and circumstances to increase its effectiveness. For example, advertising can be targeted to particular users or user groups, or to circumstances associated with the user or the advertising context or environment. Such targeted advertising can include, for example, behavioral targeting, geotargeting, time-based, contextual targeting, and others. Of course, in sponsored search, advertising can also be targeted based at least in part on a user's keyword query as well as other query-based historical information.

Some targeting techniques take into account various aspects of advertisements, and seek to match advertisements with various targeting parameters. For example, some techniques build lists of advertisements based on such a matching process. Advertisements may be ranked in the lists based on a degree of overall matching or relevance, or based on a score assigned to advertisements to represent the associated degree of matching or relevance. Some techniques may then use many such lists in determining and assembling a list of advertisements ranked in order of determined matching or relevance based on all considered targeting parameters.

Techniques as described above, as well as many other techniques in advertising and other technologies, may require sorting of partially sorted lists. In online advertising, for example, providing relevant advertisements extremely rapidly is crucial for increasing advertisement effectiveness, user click through or other response, associated revenue, etc. Determining ranked lists of advertisements, which can include sorting partially sorted lists, can account for a large fraction of run-time or delay. Furthermore, as the advertising scale increases, such as by including a larger number of advertisements, targeting parameters, etc., the challenge of rapidly and effectively sorting partially sorted lists becomes even more critical

There is a need for systems and methods for sorting partially sorted lists or other data sets.

### SUMMARY

In some embodiments, the invention provides methods and systems for determining whether to use a full sort sorting technique or a merge sort sorting technique to sort a partially sorted list or data set. One or more tables may be utilized to allow such a determination to be made with regard to a first partially sorted list based on parameters associated with the list including a data distribution type, a number of data items in the list, and a ratio of sorted items to unsorted items in the list.

In one embodiment, the invention provides a method including, using one or more computers, storing one or more tables of information for use in determining whether to use a full sort sorting technique or a merge sort sorting technique to sort a partially sorted data set. One or more entries in the one or more tables specify whether to use a full sort sorting technique or a merge sort sorting technique to sort a partially sorted data set with specified values for each of at least a first set of parameters. The first set of parameters includes a data distribution type, a number of data items, and a pivot point, a pivot point being a ratio of sorted items to unsorted items in a data set. The method further includes, using one or more computers, matching a first partially sorted data set to a corresponding one or more entries in the one or more tables based at least on values for each of the first set of parameters associated with the first partially sorted data set. The method further includes, using one or more computers, using the corresponding one or more entries in the one or more tables to determine whether to use a full sort sorting technique or a merge sort sorting technique to sort the first partially sorted data set. The method further includes, using one or more computers, storing information specifying the determination.

In another embodiment, the invention provides a system including one or more server computers connected to the Internet, and one or more databases connected to the one or more servers. The one or more databases are for storing one or more tables of information for use in determining whether to use a full sort sorting technique or a merge sort sorting technique to sort a partially sorted data set. One or more entries in the one or more tables specify whether to use a full sort sorting technique or a merge sort sorting technique to sort a partially sorted data set with specified values for each of at least a first set of parameters. The first set of parameters includes a distribution type, a number of data items, and a pivot point, a pivot point being a ratio of sorted items to unsorted items in a data set. The one or more servers are for matching a first partially sorted data set to a corresponding one or more entries in the one or more tables based at least on values for each of the first set of parameters associated with the first partially sorted data set. The one or more servers are further for using the corresponding one or more entries in the one or more tables to determine whether to use a full sort sorting technique or a merge sort sorting technique to sort the first partially sorted data set. The one or more servers are further for storing information specifying the determination.

In another embodiment, the invention provides a computer readable medium or media containing instructions for executing a method. The method includes, using one or more computers, storing one or more tables of information for use in determining whether to use a full sort sorting technique or a merge sort sorting technique to sort a partially sorted data set. One or more entries in the one or more tables specify whether to use a full sort sorting technique or a merge sort sorting technique to sort a partially sorted data set with specified values for each of at least a first set of parameters. The first set of parameters includes a distribution type, a number of data items, and a pivot point, a pivot point being a ratio of sorted items to unsorted items in a data set. The method further includes, using one or more computers, matching a first partially sorted data set to a corresponding one or more entries in the one or more tables based at least on values for each of the first set of parameters associated with the first partially sorted data set. The method further includes, using one or more computers, using the corresponding one or more entries in the one or more tables to determine whether to use a full sort sorting technique or a merge sort sorting technique to sort the first partially sorted data set. The method further includes, using one or more computers, storing information specifying the determination.

### BRIEF DESCRIPTION OF THE DRAWINGS

FIG. 1 is a distributed computer system according to one embodiment of the invention;

FIG. 2 is a flow diagram of a method according to one embodiment of the invention;

FIG. 3 is a conceptual block diagram according to one embodiment of the invention;

FIG. 4 is a conceptual block diagram according to one embodiment of the invention; and

FIG. 5 is a flow diagram of a method according to one embodiment of the invention.

While the invention is described with reference to the above drawings, the drawings are intended to be illustrative, and the invention contemplates other embodiments within the spirit of the invention.

### DETAILED DESCRIPTION

Methods and systems are provided for determining whether to use a full sort sorting technique or a merge sort sorting technique to sort a partially sorted list or data set. One or more tables may be utilized to allow such a determination to be made with regard to a first partially sorted list based on parameters associated with the list including a data distribution type, a number of data items in the list, and a ratio of sorted items to unsorted items in the list.

The present invention is described primarily in connection with advertising, but can apply in apply context involving or requiring sorting of partially sorted lists.

In online advertising, it is important to serve online advertisements to users as rapidly as possible. For example, in a sponsored search context, it is important to serve advertisements with minimal delay following entry of a keyword-based query. It is also important to minimize usage and time consumption relating to computational resources. These factors become even more important, and difficult to manage, as data scale increases. Since online advertising often requires sorting of partially sorted lists, for example, in order to determine best, top-ranked advertisements, it is important to sort such lists as rapidly as possible, and using minimal computational resources.

A number of full sort and merge sort sorting techniques are known in the art. However, neither type of sorting technique is always best for sorting partially sorted lists (or data sets). Rather, whether a full sort or a merge sort sorting technique is faster may depend on a number of parameters associated with the partially sorted list to be sorted. In particular, relevant parameters associated with the partially sorted list can include data distribution type, pivot point (pivot point being defined as a ratio of sorted items to unsorted items in a list or data set), and the number of items in the list.

In some embodiments of the invention, processing time and resources are decreased by determining whether, for a partially sorted list with a particular set of parameter values, a full sort technique or a merge sort technique is faster and more efficient.

Furthermore, in some embodiments, speed and efficiency is further increased by utilizing one or more tables that may be generated offline from test or example data. For example, tables may be generated which, alone or in combination, for a particular combination of parameters, specify whether a full sort or a merge sort technique is anticipated to be faster or more efficient. Since the table or tables may be generated offline, offline resources and processing can be leveraged so that online processing time and delay can be further reduced.

In various embodiments, tables can be generated in different ways, and different combinations of tables may be used. For example, in some embodiments, a single table may be generated that indicates a whether a full sort technique or a merge sort technique is best, based on entries in the table that specify the type of technique (full sort or merge sort) in association with a given set of parameters. In other embodiments, different sets of tables may be utilized, which together may be used to associate appropriate parameter values or ranges with a best sort technique type.

For example, in some embodiments, tables are generated offline in connection with an anticipated range of parameter values. Entries in the tables may specify whether a full sort or a merge sort technique is anticipated to be faster, for a given set of parameter values. Online, a list or data set may be analyzed to determine a data distribution type that it matches or most closely resembles among a group of specified or designated data distribution types. Furthermore, a pivot point value, or estimated or approximate pivot point value, may be determined. Still further, a total number of items, or an estimated or approximate total number of items, may be determined. Finally, the one or more tables may be used to determine or look up whether a full sort or a merge sort technique is anticipated to be faster for that data set. A known full sort or merge sort technique or algorithm may then be applied. Alternately, once it is determined whether to use a full sort technique or a merge sort technique to sort the list, or a technique or algorithm for choosing an appropriate full sort or merge sort technique (as appropriate) may be utilized, and then an appropriate technique of the appropriate type may be utilized.

In some embodiments, a two step method may be utilized. As a first step, a data distribution associated with a particular partially sorted list may be identified. For example, a best fit or approximation method may be used to determine which, among a number of data distribution types, the data of the list most resembles. As a second step, a pivot point and number of items associated with the list may be determined. Finally, offline-generated tables may be utilized to determine a best type of sort technique to be used.

In some embodiments, a threshold pivot point may be identified, for example, in connection with other parameter values, beyond which a merge sort technique is designated to be best (since a merge sort technique tends to be fastest when the pivot point value is high enough, meaning the ratio of sorted to unsorted items in the list is sufficiently high).

In some embodiments, an advantage of the invention is that it is platform independent, and requires no custom hardware. Furthermore, techniques according to the invention can be decoupled from such things as advertisement ranking algorithms, so that the techniques are transparent to server users or programmers and designers, as well as to users being served advertisements.

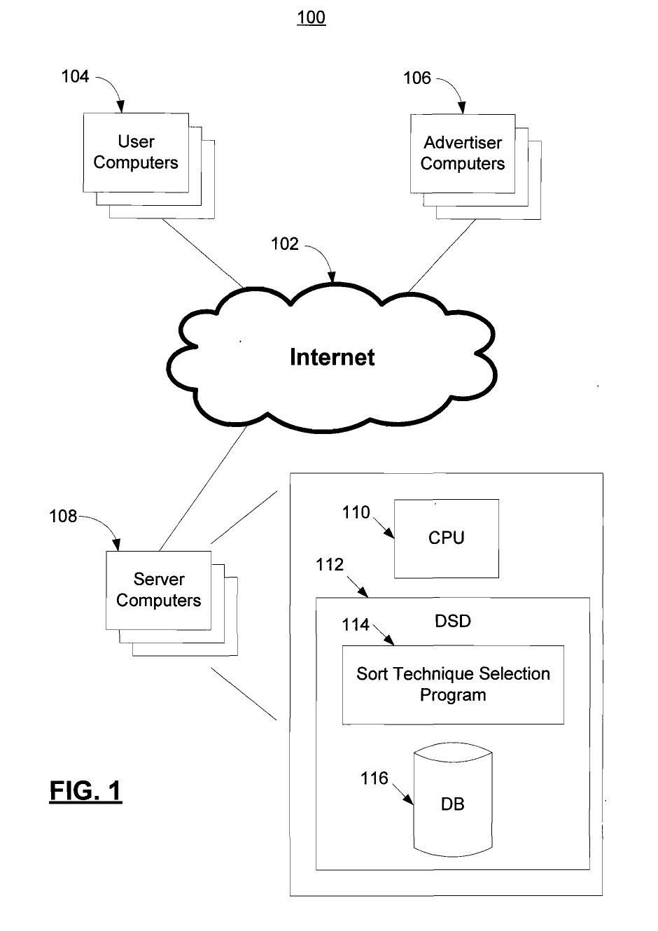

FIG. 1 is a distributed computer system 100 according to one embodiment of the invention. The system 100 includes user computers 104, advertiser computers 106 and server computers 108, all connected or connectable to the Internet 102. Although the Internet 102 is depicted, the invention contemplates other embodiments in which the Internet is not includes, as well as embodiments in which other networks are included in addition to the Internet, including one more wireless networks, WANs, LANs, telephone, cell phone, or other data networks, etc. The invention further contemplates embodiments in which user computers or other computers may be or include a wireless, portable, or handheld devices such as cell phones, PDAs, etc.

Each of the one or more computers 104, 106, 108 may be distributed, and can include various hardware, software, applications, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, and software to enable searching, search results, and advertising, such as keyword searching and advertising in a sponsored search context.

As depicted, each of the server computers 108 includes one or more CPUs 110 and a data storage device 112. The data storage device 112 includes a database 116 and a sort technique selection program 114.

The sort technique selection program 114 is intended to broadly include all programming, applications, software and other and tools necessary to implement or facilitate methods and systems according to embodiments of the invention, whether on one computer or distributed among multiple computers.

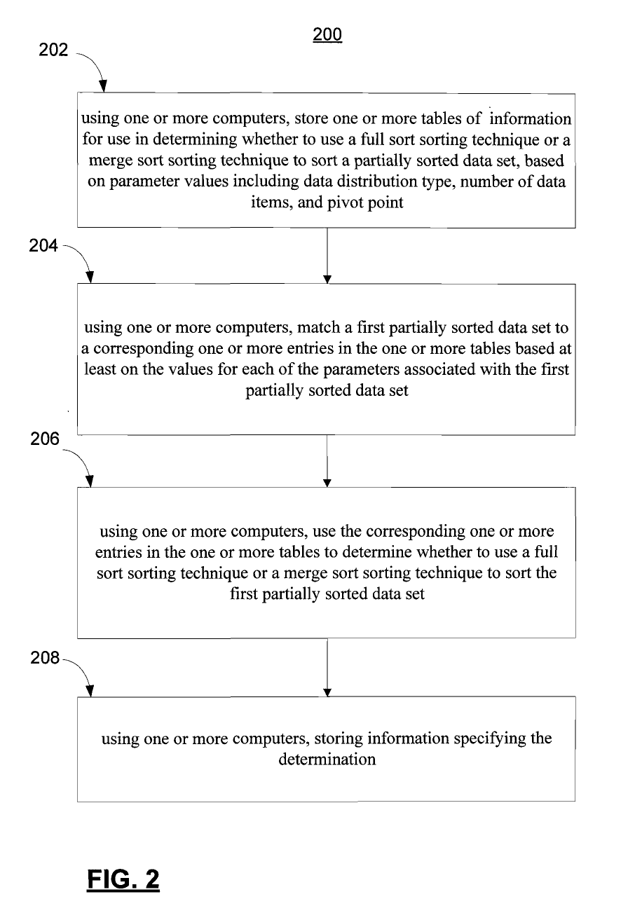

FIG. 2 is a flow diagram of a method 200 or algorithm according to one embodiment of the invention. The method 200 can be carried out or facilitated using sort technique selection program 114.

At step 202, using one or more computers, one or more tables of information are stored, for use in determining whether to use a full sort sorting technique or a merge sort sorting technique to sort a partially sorted data set, based on parameter values including data distribution type, number of data items, and pivot point.

Next, at step 204, using one or more computers, a first partially sorted data set is matched to a corresponding one or more entries in the one or more tables based at least on the values for each of the parameters associated with the first partially sorted data set.

Next, at step 206, using one or more computers, the corresponding one or more entries in the one or more tables are used to determine whether to use a full sort sorting technique or a merge sort sorting technique to sort the first partially sorted data set.

Finally, at step 208, using one or more computers, information is stored specifying the determination.

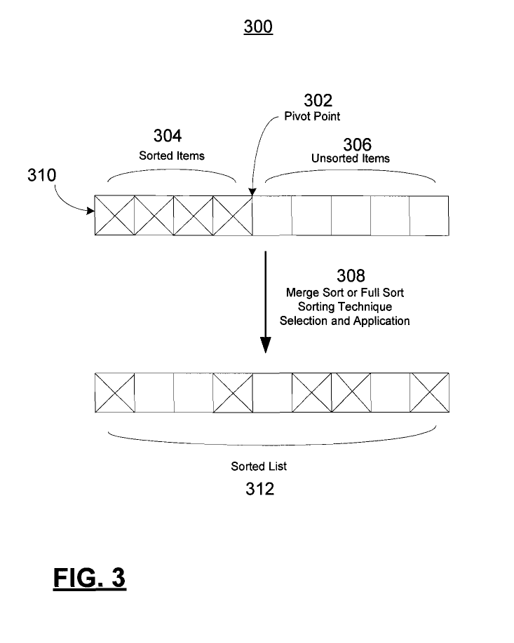

FIG. 3 is a conceptual block diagram 300 according to one embodiment of the invention. Depicted in FIG. 3 is a partially sorted data set or list 310 that includes sorted items 304 and unsorted items 306. A pivot point 302 is conceptually depicted, the pivot point being defined as the ratio of sorted items to unsorted items in the list.

Step 308 represents selection and application of a full sort or a merge sort sorting technique. In some embodiments, step 308 is carried out or facilitating using the sort technique selection program 114 as depicted in FIG. 1. For example, step 308 may include determination or a matching or best fit data distribution type in connection with the list 310. Step 308 may further include determination or approximation of the number of items in the list 310, as well as determination or approximation of the pivot point 302 associated with the list. Step 308 may further include access to or looking up of relevant entries in one or more off-line generated tables to determine, based at least on the associated data distribution type, number of items, and pivot point, whether to use a full sort or a merge sort sorting technique.

FIG. 3 further depicts a sorted list 312, following selection and application of a full sort or a merge sort sorting technique in step 308.

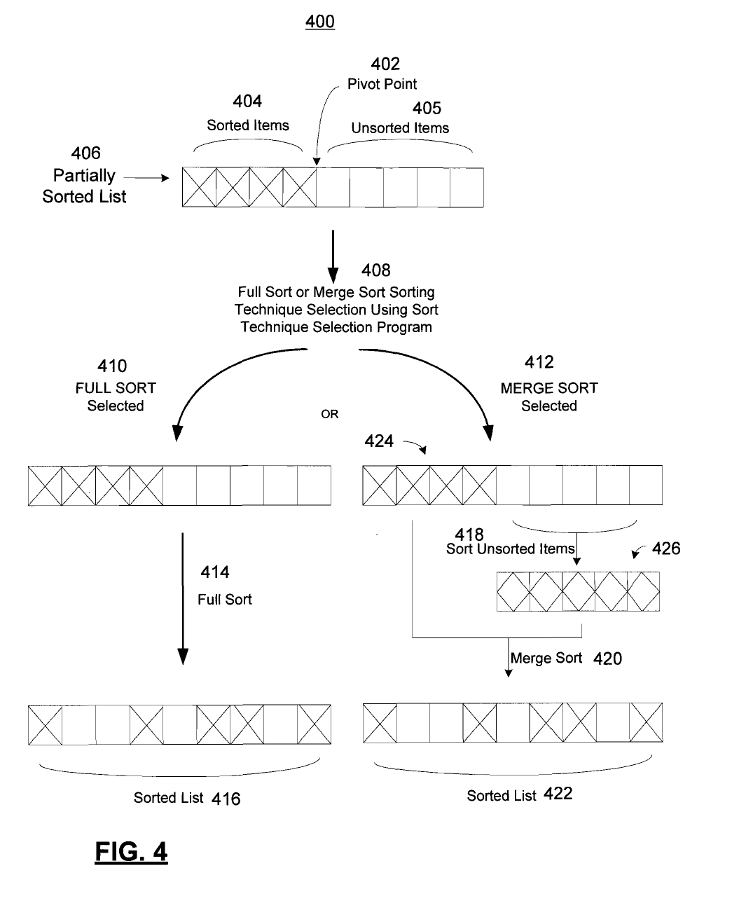

FIG. 4 is a conceptual block diagram 400 according to one embodiment of the invention. Depicted in FIG. 4 is a partially sorted data set or list 406, including sorted items 404 and unsorted items 405, and a conceptually depicted pivot point 402.

Step 408 represents determining whether to use a full sort or a merge sort sorting technique to sort the list 406. Step 408 may be carried out by or facilitated by the sort technique selection program 114. Step 408 my include determining or approximating a data distribution type, number or items, and pivot point associated with the list, and then utilizing one or more off-line generated tables to determine or look up whether to use a full sort or a merge sort sorting technique to sort the list 406.

If a full sort sorting technique is indicated, then a full sort is performed at step 414 to produce a sorted list 416.

If a merge sort sorting technique is indicated, then a merge sort is performed at steps 418 and 420 to produce a sorted list 422. Specifically, the merge sort technique includes first sorting the unsorted items in the list at step 418, and then merge sorting the originally sorted items 424 and the newly sorted items 426 to produce a sorted list 422.

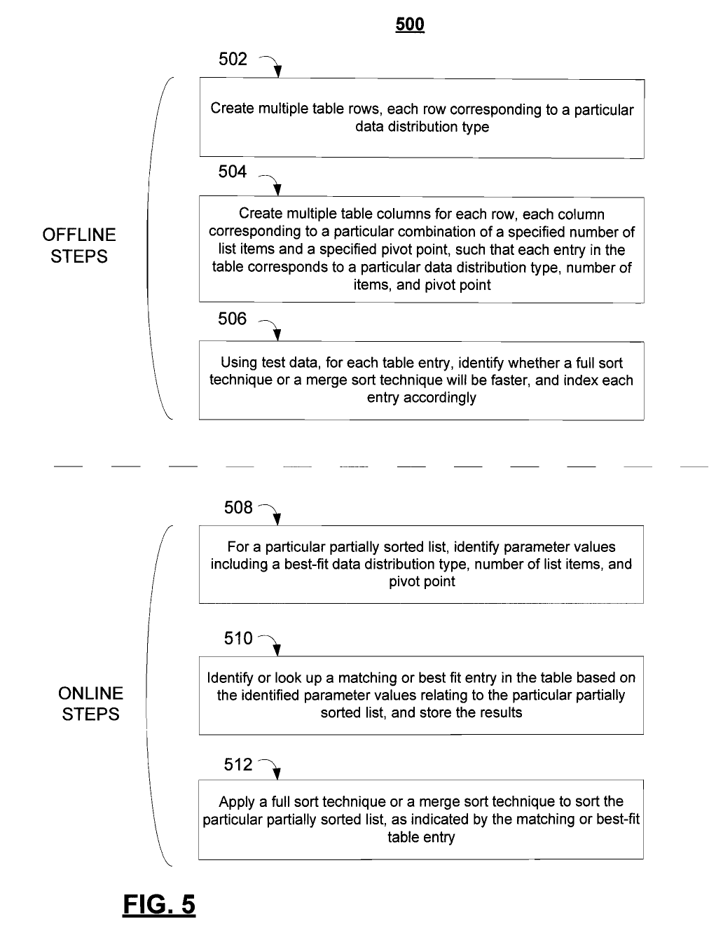

FIG. 5 is a flow diagram of a method 500 according to one embodiment of the invention. The method 500 may be carried out or facilitated by the sort technique selection program 114 as depicted in FIG. 1.

Steps 502, 504, and 506 of the method 500 may be carried out offline, such as based on example or test data. The table or tables generated offline can then be used for online determination or whether to use a full sort or a merge sort sorting technique to sort a particular partially sorted data set or list.

At step 502, multiple table rows are created, each row corresponding to a particular data distribution type.

Next, at step 504, multiple table columns are created for each row, each column corresponding to a particular combination of a specified number of list items and a specified pivot point, such that each entry in the table corresponds to a particular data distribution type, number of items, and pivot point.

Next, at step 506, using test data, for each table entry, it is identified whether a full sort technique or a merge sort technique will be faster, and each entry, or each appropriate entry, in the table is indexed accordingly.

Steps 508, 510, and 512 may be carried out online, such as in connection with a particular data set or list.

At step 508, for a particular partially sorted list, parameter values are identified, including a best-fit data distribution type, number of list items, and pivot point associated with a subject partially sorted list.

At step 510, a matching or best fit entry is identified or looked up in the table based on the identified parameter values relating to the particular partially sorted list, and the results are stored, such as in the database 116 depicted in FIG. 1.

Finally, at step 512, a full sort technique or a merge sort technique is applied to sort the particular partially sorted list, as indicated by the matching or best-fit table entry.

The foregoing description is intended to be illustrative, and other embodiments are contemplated within the spirit of the invention.

What is claimed is:

1. A method comprising:
using one or more computers, storing one or more tables of information for use in determining whether to use a full sort sorting technique or a merge sort sorting technique to sort a partially sorted data set;
wherein one or more entries in the one or more tables specify whether to use a full sort sorting technique or a merge sort sorting technique to sort a partially sorted data set with specified values for each of at least a first set of parameters;
and wherein the first set of parameters includes a data distribution type, a number of data items, and a pivot point, a pivot point being a ratio of sorted items to unsorted items in a data set;
using one or more computers, matching a first partially sorted data set to a corresponding one or more entries in the one or more tables based at least on values for each of the first set of parameters associated with the first partially sorted data set;
using one or more computers, using the corresponding one or more entries in the one or more tables to determine whether to use a full sort sorting technique or a merge sort sorting technique to sort the first partially sorted data set; and
using one or more computers, storing information specifying the determination.

2. The method of claim 1, comprising generating the one or more tables offline using test data.

3. The method of claim 1, determining the data distribution parameter value associated with the first partially sorted data set by associating a data distribution of the first data set with one of a plurality of predetermined data distribution types.

4. The method of claim 1, wherein associating a data distribution the first data set with one of a plurality of predetermined data distribution types comprises determining a predetermined data distribution type of the plurality that most closely matches a determined data distribution of the first partially sorted data set.

5. The method of claim 1, further comprising, based on the stored determination of whether to use a full sort or a merge sort sorting technique, using a full sort sorting technique or a merge sort sorting technique to sort the first partially sorted data set, and further comprising storing results of the sort.

6. The method of claim 1, wherein determining parameter values associated with the first partially sorted data set comprises determining parameter values associated with a ranked list of targeted advertisements.

7. The method of claim 1, wherein storing one or more tables comprises:
generating rows of at least one table, each of the rows corresponding to a data distribution type; and
generating columns of the at least one table, each of the columns corresponding to a particular combination of data set parameter values for parameters including data distribution type, pivot point, and number of items.

8. The method of claim 1, wherein determining whether to use a full sort sorting technique or a merge sort sorting technique comprises determining whether a full sort sorting technique or a merge sort sorting technique is anticipated to be faster to perform.

9. The method of claim 8, wherein the first partially sorted data set comprises a list, and comprising determining whether to use a full sort or a merge sort sorting technique to sort the list as a step in assembling a ranked list of sponsored search advertisements.

10. A system comprising:
one or more server computers connected to the Internet; and
one or more databases connected to the one or more servers;
wherein the one or more databases are for:
storing one or more tables of information for use in determining whether to use a full sort sorting technique or a merge sort sorting technique to sort a partially sorted data set;
wherein one or more entries in the one or more tables specify whether to use a full sort sorting technique or a merge sort sorting technique to sort a partially sorted data set with specified values for each of at least a first set of parameters,
and wherein the first set of parameters includes a distribution type, a number of data items, and a pivot point, a pivot point being a ratio of sorted items to unsorted items in a data set;
and wherein the one or more servers are for:
matching a first partially sorted data set to a corresponding one or more entries in the one or more tables based at least on values for each of the first set of parameters associated with the first partially sorted data set;
using the corresponding one or more entries in the one or more tables to determine whether to use a full sort sorting technique or a merge sort sorting technique to sort the first partially sorted data set; and
storing information specifying the determination.

11. The system of claim 10, wherein the one or more servers are further for sorting the first partially sorted data set using a full sort sorting technique or a merge sort sorting technique based on the stored determination of whether to use a full sort sorting technique or a merge sort sorting technique.

12. The system of claim 10, wherein the databases are further for storing results of sorting of the first partially sorted data set.

13. The system of claim 12, wherein sorting the first partially sorted data set is a step in generating a ranked list of advertisements.

14. The system of claim 13, wherein the ranked list of advertisements comprises a ranked list of targeted advertisements.

15. The system of claim 14, wherein the ranked list of targeted advertisements is ranked for serving to one or more users according to a relevance determination.

16. The system of claim 15, wherein the ranked list of targeted advertisements is a ranked list of sponsored search advertisements, and wherein the relevance determination is based at least in part on a keyword query.

17. The system of claim 10, comprising generating the one or more tables offline using test data.

18. The method of claim 10, wherein storing one or more tables comprises:
generating rows of at least one table, each of the rows corresponding to a data distribution type; and
generating columns of the at least one table, each of the columns, each of the columns corresponding to a particular combination of data set parameter values for parameters including data distribution type, pivot point, and number of items.

19. The method of claim 10, wherein determining whether to use a full sort sorting technique or a merge sort sorting technique comprises determining whether a full sort sorting technique or a merge sort sorting technique is anticipated to be more efficient.

20. A computer readable medium or media containing instructions for executing a method, the method comprising:
using one or more computers, storing one or more tables of information for use in determining whether to use a full sort sorting technique or a merge sort sorting technique to sort a partially sorted data set;
wherein one or more entries in the one or more tables specify whether to use a full sort sorting technique or a merge sort sorting technique to sort a partially sorted data set with specified values for each of at least a first set of parameters;
and wherein the first set of parameters includes a distribution type, a number of data items, and a pivot point, a pivot point being a ratio of sorted items to unsorted items in a data set;
using one or more computers, matching a first partially sorted data set to a corresponding one or more entries in the one or more tables based at least on values for each of the first set of parameters associated with the first partially sorted data set;
using one or more computers, using the corresponding one or more entries in the one or more tables to determine whether to use a full sort sorting technique or a merge sort sorting technique to sort the first partially sorted data set; and
using one or more computers, storing information specifying the determination.
